(19) United States
(12) Patent Application Publication
(10) Pub. No.: US 2004/0198882 A1
(43) Pub. Date: Oct. 7, 2004

(54) Silica-containing coating composition for forming films and method for forming silica-containing films

(75) Inventor: Kazuo Fujita, Haibara-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/811,872

(22) Filed: Mar. 30, 2004

(30) Foreign Application Priority Data
Mar. 31, 2003 (JP) 2003-95784
Mar. 31, 2003 (JP) 2003-95785
Mar. 31, 2003 (JP) 2003-95786

(51) Int. Cl. C08K 5/24; C08K 3/34

(52) U.S. Cl. 524/261; 524/492

(57) ABSTRACT

A coating composition for forming a silica-containing film comprises (A) a hydrolyzate and/or partially condensed product of a compound represented by the following general formula (I) and a compound represented by the following general formula (II):

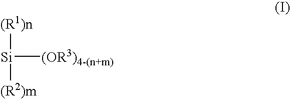

wherein R¹ represents a hydrogen atom, an alkyl group or an aryl group; R² represents an organic group having an unsaturated bond; R³ represents an alkyl group; n ranges from 0 to 2; m ranges from 1 to 3, provided that 0≦n+m≦3; and

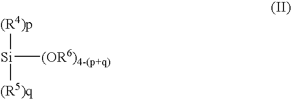

wherein R⁴ represents an alkyl group or an aryl group; R⁵ represents a hydrogen atom; R⁶ represents an alkyl group; and p and q are integers satisfying the relation: 0≦p+q≦3; (B) a solvent for coating; and (C) at least one member selected from the group consisting of a void-forming solvent, a compound having a polyalkylene oxide structure and hollow polymer fine particles. The silica-containing film obtained from the composition is excellent in the heat resistance, adhesive properties and resistance to cracking and has a low dielectric constant. Accordingly, the composition is suitable used as a material for forming an interlayer insulating film in the field of, for instance, semiconductor elements.

### Background of the Invention

The present invention relates to a material for forming an insulating film and more specifically to an insulating film-forming material which permits the formation of a coated film having a uniform thickness, suitably used as a material for an interlayer insulating film of, for instance, a semiconductor element and the formation of an insulating film hardly undergoing any crack formation and which permits the formation of an insulating film excellent in, for instance, the dielectric characteristics and an ability of being adhered to the neighboring films, in particular, to an insulating film-forming material suitably used for the formation of a porous insulating film as well as an insulating film-forming method, which makes use of the material and an insulating film.

As the interlayer (layer-to-layer) insulating film used in, for instance, a semiconductor element, there have conventionally widely been used a silica (SiO₂) film formed by a vacuum process such as the CVD technique. Moreover, there has also been used recently a coated insulating film comprising, as a principal component, a hydrolyzate of tetra-alkoxy silane called the SOG (Spin on Glass) film for the purpose of forming a more uniform interlayer insulating film. In addition, there has also been developed an interlayer insulating film having a low dielectric constant and mainly comprising polyorgano-siloxane called organic SOG, along with the increase in the level of integration of, for instance, a semiconductor element.

However, the CVD-deposited SiO₂ film having the lowest dielectric constant among the films of inorganic materials has a dielectric constant on the order of about 4. Moreover, an SiOF film, which has recently been investigated as a low dielectric CVD film has a dielectric constant of about 3.3 to 3.5, but this film suffers from such a problem that its dielectric constant increases during using the same because of its high hygroscopicity.

On the other hand, an organic polymer film having a low dielectric constant on the order of 2.5 to 3.0 suffers from a problem such that distributing wires are significantly damaged because of its low glass transition point on the order of 200 to 350° C. and its high thermal expansion coefficient. Further, SOG films suffer from a problem in that they easily cause cracking due to the volume contraction when curing the same. In addition, organic SOG films are susceptible to oxidation by the oxygen plasma ashing, which has been used for peeling resist films during forming a multi-layer wiring pattern and this in turn leads to the formation of cracks.

Furthermore, an organic resin containing organic SOG is inferior in the adhesion to wiring materials such as aluminum and aluminum-based alloys and copper and copper-based alloys. For this reason, the resin would form voids (interstices formed between the wires and the insulating material) in the proximity to the distributing wires, moisture may penetrate into the voids to thus cause corrosion of the wires, the voids in the proximity to the wires results in the formation of a short circuit between the wiring layers, which cause aberration of positions when forming a via hole to realize the intended multi-layer wiring and this may substantially reduce the reliability of the resulting device.

Under such circumstances, there has been known a coat-type composition for forming an insulating film, which comprises organo-polysiloxane as an insulating film-forming material excellent in the insulating properties, heat resistance and durability (see the following patent reference 1). Moreover, there has also been known a method for the improvement of the adhesion while making use of a polysiloxane having an unsaturated bond, wherein the resulting film is made porous through the use of a thermally decomposed polymer to thus reduce the dielectric constant thereof (see the following patent reference 2). However, this method suffers from a problem such that the resulting film undergoes cracking upon heating. In addition, there has also been known a method which makes use of a compound having a boiling point or decomposition temperature ranging from 250 to 450° C. for making organo-polysiloxane porous to thus reduce the dielectric constant of the resulting film (see the following patent reference 3).

Patent Reference 1: Japanese Un-Examined Patent Publication 2000-329217

Patent Reference 2: Japanese Un-Examined Patent Publication 2001-279163

Patent Reference 3: Japanese Un-Examined Patent Publication 2002-285086

However, there has been desired for the development of a technique for further improvement of the electrical insulation between conductors along with the higher level of integration and/or higher multi-layer structure of, for instance, semiconductor elements and for the development of an interlayer insulation material having a lower dielectric constant and excellent in the resistance to cracking, heat resistance and adhesion to other materials. The foregoing insulating film-forming material comprising the known polysiloxane is still insufficient in, for instance, heat resistance, resistance to cracking, adhesion and dielectric characteristics.

### DISCLOSURE OF THE INVENTION

Accordingly, it is generally an object of the present invention to provide a film-forming composition which can solve the foregoing problems associated with the conventional techniques and more specifically, to provide a film-forming composition which permits the formation of a coated film having a uniform thickness suitably used as an interlayer insulating film of, for instance, a semiconductor element and which likewise permits the formation of a film hardly undergoing any crack formation and excellent in, for instance, heat resistance, adhesive properties and even in dielectric characteristics.

It is another object of the present invention to provide a film-forming method which makes use of the foregoing film-forming composition and a film obtained from the foregoing film-forming composition.

The present invention herein provides a coating composition for forming a silica-containing film as will be detailed below as well as a film-forming method which makes use of the foregoing film-forming composition and a film obtained from the foregoing film-forming composition.

1. A coating composition for forming a silica-containing film comprises (A) a hydrolyzate and/or partially condensed product of a compound represented by the following general formula (I) and a compound represented by the following general formula (II):

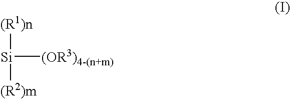

wherein R¹ represents a hydrogen atom, an alkyl group having 1 to 18 carbon atoms or an aryl group having 6 to 14 carbon atoms; R² represents an organic group having an unsaturated bond and 2 to 12 carbon atoms; R³ represents an alkyl group having 1 to 6 carbon atoms; n is an integer ranging from 0 to 2; m is an integer ranging from 1 to 3, provided that n and m are selected such that they satisfy the following relation: 0≦n+m≦3; and

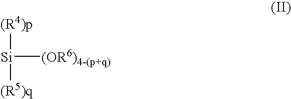

wherein R⁴ represents an alkyl group having 1 to 18 carbon atoms or an aryl group having 6 to 14 carbon atoms; R⁵ represents a hydrogen atom; R⁶ represents an alkyl group having 1 to 6 carbon atoms; and p and q are integers selected in such a manner that they satisfy the following relation: 0 ≦p+q≦3;

(B) a solvent for coating; and

(C) at least one member selected from the group consisting of a void-forming solvent, a compound having a polyalkylene oxide structure and hollow polymer fine particles.

2. The coating composition for forming a silica-containing film as set forth in the foregoing item 1, wherein the component (C) is a void-forming solvent.

3. The coating composition for forming a silica-containing film as set forth in the foregoing item 1, wherein the component (C) is a compound having a polyalkylene oxide structure.

4. The coating composition for forming a silica-containing film as set forth in the foregoing item 1, wherein the component (C) is hollow polymer fine particles.

5. A method for forming a silica-containing film comprises the steps of applying a coating composition for forming a silica-containing film as set forth in any one of the foregoing items 1 to 4 onto a base material or a substrate and then drying the coated layer.

6. A silica-containing film obtained from a coating composition for forming a silica-containing film as set forth in any one of the foregoing items 1 to 4.

The component (A) of the present invention or the hydrolyzate and/or partially condensed product (partial condensate) of the compound of Formula (I) and the compound of Formula (II) may be hydrolyzates and/or partial condensates of the compound of Formula (I) or the compound of Formula (II) or mixture thereof or hydrolyzates and/or partial condensates of mixtures of the compound of Formula (I) and the compound of Formula (II).

When the composition of the present invention comprising polyorgano-siloxane as a base polymer is applied onto a base material such as a silicon wafer by a coating method such as a dip coating or spin coating method, the composition can certainly fill up, for instance, the gaps present between fine patterns. As a result, if the organic solvent used for the coating is removed and the layer is crosslinked, through heating, a vitreous or macromolecular film is formed. The resulting film is excellent in the heat resistance and adhesion to other materials, has a low dielectric constant and never undergoes the formation of any crack. Accordingly, the composition of the invention permits the formation of a thick insulating film.

### BEST MODE FOR CARRYING OUT THE INVENTION

The compounds used in the present invention will now be described in more detail below.

Component (A): the hydrolyzate and/or partially condensed product (partial condensate) of the compound of Formula (I) and the compound of Formula (II)

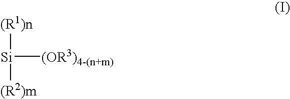

wherein R¹ represents a hydrogen atom, an alkyl group having 1 to 18 carbon atoms or an aryl group having 6 to 14 carbon atoms; R² represents an organic group having an unsaturated bond and 2 to 12 carbon atoms; R³ represents an alkyl group having 1 to 6 carbon atoms; n is an integer ranging from 0 to 2; m is an integer ranging from 1 to 3, provided that n and m are selected such that they satisfy the following relation: 0≦n+m≦3.

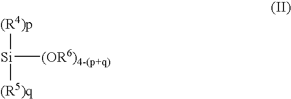

wherein R⁴ represents an alkyl group having 1 to 18 carbon atoms or an aryl group having 6 to 14 carbon atoms; R⁵ represents a hydrogen atom; R⁶ represents an alkyl group having 1 to 6 carbon atoms; and p and q are integers selected in such a manner that they satisfy the following relation: 0≦p+q≦3.

Examples of the foregoing alkyl groups having 1 to 18 carbon atoms include methyl, ethyl, propyl, isopropyl, n-butyl, sec-butyl, tert-butyl, amyl, isoamyl, hexyl, cyclohexyl, octyl, 2-ethylhexyl, nonyl, decyl and octadecyl groups. Examples of the foregoing aryl groups having 6 to 14 carbon atoms are phenyl, tolyl, amino-phenyl and naphthyl groups. Among these groups, preferred are methyl and phenyl groups, with a methyl group being more preferred.

Examples of organic groups having 2 to 12 carbon atoms are alkenyl groups such as vinyl, allyl, cyclohexenyl, methacryloxy and methacryloxy-propyl groups; alkynyl groups such as ethynyl and 5-hexenyl groups; and carbonyl-containing substituents such as 3-acryloxypropyl, methacryloxy-propyl and acetate groups. Among them, preferably used herein are vinyl and allyl groups, with vinyl group being more preferably used herein.

Examples of alkyl groups having 1 to 6 carbon atoms are methyl, ethyl, propyl, isopropyl, n-butyl, sec-butyl, tert-butyl, amyl, isoamyl, hexyl and cyclohexyl groups, preferably methyl and ethyl groups and more preferably a methyl group.

In the hydrolyzate and/or partial condensate, the content of the compound represented by Formula (I) preferably ranges from 1 to 50% by mass and more preferably 5 to 30% by mass.

In addition, the content of the component (A) in the coating composition of the present invention preferably ranges from 1 to 50% by mass and more preferably 1 to 30% by mass.

Component (B): Solvent for Coating

The solvents used for coating the composition are desirably those having a boiling point of preferably not less than 50° C., more preferably not less than 100° C. and not more than 200° C. Specific examples thereof are ethylene dichloride, cyclohexanone, cyclopentanone, 2-heptanone, methyl isobutyl ketone, γ-buryrolactone, methyl ethyl ketone, methanol, ethanol, dimethyl-imidazolidinone, ethylene glycol mono-methyl ether, ethylene glycol mono-ethyl ether, ethylene glycol dimethyl ether, 2-methoxyethyl acetate, ethylene glycol mono-ethyl ether acetate, propylene glycol mono-methyl ether (PGME), propylene glycol mono-methyl ether acetate (PGMEA), tetraethylene glycol dimethyl ether, tri-ethylene glycol mono-butyl ether, tri-ethylene glycol mono-methyl ether, isopropanol, ethylene carbonate, ethyl acetate, butyl acetate, methyl lactate, ethyl lactate, methyl methoxy-propionate, ethyl ethoxy-propionate, methyl pyruvate, ethyl pyruvate, propyl pyruvate, N,N-dimethyl-formamide, dimethyl-acetamide, dimethyl-sulfoxide, N-methyl-pyrrolidone, tetrahydrofuran, di-isopropyl benzene, toluene, xylene and mesitylene, which may be used alone or in any combination.

Among the solvents listed above, more preferably used herein are propylene glycol mono-methyl ether acetate, propylene glycol mono-methyl ether, 2-heptanone, cyclohexanone, γ-buryrolactone, ethylene glycol mono-methyl ether, ethylene glycol mono-ethyl ether, ethylene glycol mono-methyl ether acetate, ethylene glycol mono-ethyl ether acetate, propylene glycol mono-methyl ether, propylene glycol mono-ethyl ether, ethylene carbonate, butyl acetate, methyl lactate, ethyl lactate, methyl methoxy-propionate, ethyl ethoxy-propionate, N-methyl-pyrrolidone, N,N-dimethyl-formamide, tetrahydrofuran, methyl isobutyl ketone, xylene, mesitylene and di-isopropyl benzene.

The content of the component (B) or the solvent for coating in the coating composition of the present invention preferably ranges from 1 to 95% by mass and more preferably 10 to 90% by mass.

Component (C): at least one member selected from the group consisting of a void-forming solvent, a compound having a polyalkylene oxide structure and hollow polymer fine particles:

Component (C1): void-forming solvent:

The void-forming solvent is desirably one having a boiling point of preferably not less than 200° C. and more preferably not less than 250° C. Particularly, preferred are alcohols or diols having a boiling point of not less than 250° C. Specific examples of such alcohols or diols having a boiling point of not less than 250 ° C. usable herein are dodecanol, tetradecanol, hexadecanol, octadecanol, 1,2-decanediol, 1,2-dodecanediol, 1,2-tetradecanediol, 1,2-hexadecanediol, 1,8-octanediol, 1,10-decanediol, 1,12-dodecane-diol, 1,14-tetradecanediol and 1,16-hexadecanediol.

The alcohols, rather than the diols, are highly soluble in organic polysiloxane solvents and can provide an excellent coated film. The diol includes two kinds of isomers or 1,2- and 1,n-isomers, but the 1,2-isomer is preferably used herein since it is rather cheap and is easily available. These alcohols and diols may be used alone or in any combination of at least two of them.

The content of the component (C1) or the void-forming solvent in the coating composition of the present invention preferably ranges from 1 to 50% by mass and more preferably 1 to 30% by mass and the amount thereof relative to the foregoing component (A) preferably ranges from 10 to 400% by mass and more preferably 20 to 200% by mass.

In this connection, the boiling point of the component (B) or the solvent for coating is lower than that of the component (C1) or the void-forming solvent and the difference in the boiling point between these two components is preferably not less than 50° C. and more preferably not less than 100° C.

Component (C2): compound having a polyalkylene oxide structure:

In this respect, examples of such polyalkylene oxide structures are a polyethylene oxide structure, a polypropylene oxide structure, a poly(tetramethylene oxide) structure and a polybutylene oxide structure.

More specifically, examples of such compounds are ether type compounds such as polyoxyethylene alkyl ether, polyoxyethylene alkyl phenyl ether, polyoxyethylene sterol ether, polyoxyethylene lanolin derivatives, ethylene oxide derivatives of alkylphenol-formalin condensates, polyoxyethylene-polyoxypropylene block copolymers and polyoxy-ethylene-polyoxypropylene alkyl ethers; ether-ester type compounds such as polyoxy-ethylene glycerin fatty acid esters, polyoxyethylene sorbitan fatty acid esters, polyoxyethylene sorbitol fatty acid esters and polyoxyethylene fatty acid alkanolamid sulfates; and ether-ester type compounds such as polyethylene glycol fatty acid ester, ethylene glycol fatty acid esters, fatty acid mono-glycerides, polyglycerin fatty acid esters, sorbitan fatty acid esters, propylene glycol fatty acid esters and sucrose fatty acid esters.

The amount of the component (C2) used in general ranges from 5 to 100% by mass on the basis of the mass of the component (A). In this respect, the amount of the component (A) is reduced to that of the condensate of the completely condensed component (A). If the amount of the component (C2) used is less than 5% by mass, the component never show any desired effect of reducing the dielectric constant of the resulting film, while if it exceeds 100% by mass, the resulting film has a reduced mechanical strength.

Component (C3): Hollow Polymer Fine Particles:

The hollow polymer fine particles used in the present invention will now be described in detail below. The average particle size of the hollow fine particles preferably ranges from 0.03 to 10 μm, more preferably 0.05 to 3 μm and in particular, 0.1 to 0.5 μm. The inner diameter of the hollow fine particles is preferably 0.1 to 0.9 time, more preferably 0.2 to 0.9 time and particularly preferably 0.3 to 0.9 time that of the outer diameter of the same. In addition, the average specific gravity of the hollow fine particles preferably ranges from 0.5 to 1.2 and more preferably 0.6 to 1.1. In this respect, if the average particle size, the ratio of the inner diameter to the outer diameter and the average specific gravity of the hollow fine particles fall within the corresponding ranges specified above, the resulting film of the present invention accordingly has a low dielectric constant.

Such hollow polymer fine particles may be crosslinked or free of any crosslink and can be prepared according to a variety of methods (I) to (IX) specified below (see, for instance, Japanese Examined Patent Publication Hei 4-68324).

(I) A method comprises the steps of incorporating a foaming agent into crosslinkable polymer particles and then foaming the agent;

(II) A method comprises the steps of enclosing a volatile substance such as butane with crosslinkable polymer particles and then gasifying the volatile substance;

(III) A method comprises the steps of melting crosslinkable polymer particles and then blowing a gas jet such as an air jet into the molten polymer to thus enclose gas bubbles with the molten polymer;

(IV) A method comprises the steps of penetrating an alkali-swellable substance into crosslinkable or un-crosslinkable polymer particles and then making the substance swell;

(V) A method comprises the steps of preparing an oil-in-water monomer emulsion and then polymerizing the monomer;

(VI) A method comprises the steps of suspending a pigment in an unsaturated polyester solution and then polymerizing a monomer in the solution;

(VII) A two-stage crosslinking method comprises the steps of forming a polymer on a seed polymer or crosslinkable polymer particles free of any compatibility with the former through polymerization and then crosslinking the polymer;

(VIII) A method comprises the step of poly-condensation of a polymer; and (IX) A method comprises the steps of spraying crosslinkable polymer particles and then drying the same.

The foregoing method (VII) is preferably used herein among others. When carrying out the method (VII), it is particularly preferred to carry out the method according to the following embodiment. More specifically, the method comprises the steps of dispersing, in water, 100 parts by mass of a polymerizable monomer component comprising (a) 1 to 50% by mass of a crosslinkable monomer; (b) 1 to 40% by mass of an unsaturated carboxylic acid when using the same as a hydrophilic monomer, 5 to 99% by mass of a monomer when using another hydrophilic monomer or less than 40% by mass of an unsaturated carboxylic acid and 5 to 99% by mass of other hydrophilic monomer when using both of these monomers simultaneously (hereunder referred to as “(b) hydrophilic monomer(s)” for simplicity); and (c) 0 to 85% by mass of other polymerizable monomers copolymerizable with the foregoing monomers (hereunder referred to as “(c) other polymerizable monomer(s)”) in the presence of 1 to 100 parts by mass of a polymer (hereunder referred to as “different polymer(s)”; seed polymer) different from the polymer obtained through the polymerization. of the foregoing polymerizable monomer components and then polymerizing the foregoing polymerizable monomer components (see Japanese Un-Examined Patent Publication Sho 62-127336).

Alternatively, it is also possible to prepare (crosslinked) hollow polymer fine particles usable in the present invention by the seed polymerization of at least one member selected from the group consisting of (a) crosslinkable monomers, (b) hydrophilic monomers and (c) other polymerizable monomers specified above while using the (crosslinked) hollow polymer fine particles prepared by the foregoing embodiment as a seed polymer (see Japanese Un-Examined Patent Publication Nos. Hei 2-140271 and Hei 2-140272).

As the foregoing crosslinkable monomers (a), there may be listed, for instance, divinyl monomers or trivinyl monomers such as divinyl benzene, ethylene glycol di-methacrylate, 1,3-butylene glycol di-methacrylate, trimethylolpropane tri-methacrylate and allyl methacrylate and particularly preferred are divinyl benzene, ethylene glycol di-methacrylate and trimethylolpropane tri-methacrylate.

Examples of the foregoing hydrophilic monomers (b) include vinylic monomers such as vinyl pyridine, glycidyl acrylate, glycidyl methacrylate, methyl acrylate, methyl methacrylate, acrylonitrile, acrylamide, N-methylol acrylamide, N-methylol methacrylamide, acrylic acid, methacrylic acid, itaconic acid, fumaric acid, sodium styrene sulfonate, vinyl acetate, dimethyl-aminoethyl methacrylate, diethyl-aminoethyl methacrylate, 2-hydroxyethyl methacrylate and 2-hydroxypropyl methacrylate. Among these, preferred are methacrylic acid, itaconic acid and acrylic acid.

The foregoing other polymerizable monomers (c) are not restricted to particular ones insofar as they have a radical polymerizing ability and specific examples thereof include aromatic vinyl monomers such as styrene, α-methyl-styrene, p-methyl-styrene and halogenated styrenes; vinyl esters such as vinyl propionate; ethylenically unsaturated carboxylic acid alkyl esters such as ethyl methacrylate, butyl acrylate, butyl methacrylate, 2-ethylhexyl acrylate, 2-ethylhexyl methacrylate, lauryl acrylate and lauryl methacrylate; maleimide compounds such as phenyl maleimide and cyclohexyl maleimide; and conjugated di-olefins such as butadiene and isoprene. Among these monomers, styrene is preferably used herein.

The foregoing different polymer differs from one obtained by polymerizing at least one polymerizable monomer (a) to (c) specified above. The term “different” herein used is a generic term and includes, for instance, polymers obtained from different kinds of monomers; those comprising the same copolymerizable monomers, while having different molecular weights; and those comprising the same copolymerizable monomers, while differing in the rate of copolymerizable monomers.

Specific examples of such different polymers are polystyrene, carboxy-modified polystyrene, carboxy-modified styrene-butadiene copolymer, styrene-butadiene copolymer, styrene-acryl ester copolymer, styrene-methacryl ester copolymer, methacryl ester copolymer, carboxy-modified (styrene-acryl ester) copolymer and carboxy-modified (styrene-methacryl ester) copolymer. Particularly preferred different polymers are polystyrene and styrene copolymers whose styrene content is not less than 50% by mass.

The hollow polymer fine particles are preferably crosslinked. In this connection, the degree of crosslinking is preferably such that the crosslinked hollow polymer fine particles can maintain their shape when they are formed into an insulating plate by heating and pressing.

Such a method, in particular, the method (VII) detailed above permits the preparation of fine particles having such uniform particle size that the rate of particles having a particle size falling within the range of from −20% to +20% of the average particle size is not less than 70% by mass. The use of such particles would be quite preferred since they permit the more effective achievement of the object according to the present invention.

In the film-forming composition of the present invention, the amount of the component (C3) to be incorporated into the composition may appropriately be determined while taking into consideration a variety of requirements and factors such as the intended value of the dielectric constant to be imparted to the resulting film, the kinds of curable precursors used, the kinds and amounts of the hollow polymer fine particles and other factors, but the component (C3) is usually incorporated into the composition in an amount preferably ranging from 1 to 200 parts by mass, more preferably 5 to 150 parts by mass and further preferably 10 to 100 parts by mass per 100 parts by mass of the component (A) or the curable precursor (reduced to the solid content) of the film-forming composition usually in a varnish-like state.

The hollow polymer fine particles may be incorporated into the film-forming composition in the form of a dispersion thereof in water, a dispersion thereof in an organic solvent such as an alcohol or dried powder, but it is preferred that the dry powdery hollow polymer fine particles be incorporated into the varnish of the curable precursor.

Other Additives

The coating composition for forming an insulating film according to the present invention may further comprise various kinds of other additives such as colloidal silica, colloidal alumina, organic polymers and/or surfactants.

The colloidal silica is, for instance, a dispersion obtained by dispersing highly pure silicic anhydride in a hydrophilic organic solvent such as methanol, ethanol or isopropanol and it is in general a dispersion whose dispersed particles have an average particle size ranging from 5 to 30 μm and preferably 10 to 20 μm and whose solid content is on the order of 10 to 40% by mass. Specific examples of such colloidal silica are Methanol Silica Sol and Isopropanol Silica Sol available from Nissan Chemical Industries Co., Ltd.; and OSKAL available from Catalysts & Chemicals Industries Co., Ltd.

Examples of colloidal alumina include Alumina Sol 520, Alumina Sol 100 and Alumina Sol 200 available from Nissan Chemical Industries Co., Ltd.; and Alumina Clear Sol, Alumina Sol 10 and Alumina Sol 132 available from KAWAKEN Fine Chemical K.K.

Examples of organic polymers are compounds having sugar chain structures, vinyl-amide polymers, (meth)acrylate compounds, aromatic vinyl compounds, dendrimers, polyimide, polyamic acid, polyarylene, polyamide, poly(quinoxaline), poly(oxadiazole) and fluorine atom-containing polymers.

Examples of surfactants usable herein are nonionic surfactants, anionic surfactants, cationic surfactants and amphoteric surfactants as well as silicone type surfactants, poly(alkylene oxide) type surfactants and fluorine atom-containing surfactants.

Preparation of Coating Composition for Film-Formation

Method for Hydrolyzing Component (A)

When hydrolyzing the component (A), the method therefor is not restricted to specific ones and accordingly, it is sufficient that the component (A) is continuously or intermittently added to a solvent to thus conduct the hydrolyzation and condensation, but it is also possible to hydrolyze and condense the component (A) by adding a predetermined amount of the latter to a mixture consisting of the component (C), water and the component (B). In addition, the method disclosed in Japanese Un-Examined Patent Publication 2002-20689 may likewise be used in the present invention.

A catalyst is used for the hydrolyzation and/or condensation of the silane compounds represented by Formulas (I) and (II). Examples of such catalysts usable herein are metal chelate compounds, organic acids, inorganic acids, organic bases and inorganic bases.

Specific examples of such metal chelate compounds usable herein as catalysts are chelate compounds of titanium such as titanium tri-ethoxy-mono(acetyl acetonate), titanium tri-n-propoxy-mono(acetyl acetonate), titanium tri-iso-propoxy-mono(acetyl acetonate), titanium tri-n-butoxy-mono(acetyl acetonate), titanium tri-sec-butoxy-mono-(acetyl acetonate), titanium tri-tert-butoxy-mono(acetyl acetonate), titanium di-ethoxy-bis(acetyl acetonate), titanium di-n-propoxy-bis(acetyl acetonate), titanium di-iso-propoxy-bis(acetyl acetonate), titanium di-n-butoxy-bis(acetyl acetonate), titanium di-sec-butoxy-bis(acetyl acetonate), titanium di-tert-butoxy-bis(acetyl acetonate), titanium mono-ethoxy-tris-(acetyl acetonate), titanium mono-n-propoxy-tris(acetyl acetonate), titanium mono-iso-propoxy-tris(acetyl acetonate), titanium mono-n-butoxy-tris(acetyl acetonate), titanium mono-sec-butoxy-tris(acetyl acetonate), titanium mono-tert-butoxy-tris(acetyl acetonate), titanium tetrakis(acetyl acetonate), titanium tri-ethoxy-mono(ethyl acetoacetate), titanium tri-n-propoxy-mono(ethyl acetoacetate), titanium tri-iso-propoxy-mono(ethyl acetoacetate), titanium tri-n-butoxy-mono(ethyl acetoacetate), titanium tri-sec-butoxy-mono(ethyl acetoacetate), titanium tri-tert-butoxy-mono(ethyl acetoacetate), titanium di-ethoxy-bis(ethyl acetoacetate), titanium di-n-propoxy-bis-(ethyl acetoacetate), titanium di-iso-propoxy-bis(ethyl acetoacetate), titanium di-n-butoxy-bis(ethyl acetoacetate), titanium di-sec-butoxy-bis(ethyl acetoacetate), titanium di-tert-butoxy-bis(ethyl acetoacetate), titanium mono-ethoxy-tris(ethyl acetoacetate), titanium mono-n-propoxy-tris(ethyl acetoacetate), titanium mono-iso-propoxy-tris-(ethyl acetoacetate), titanium mono-n-butoxy-tris(ethyl acetoacetate), titanium mono-sec-butoxy-tris(ethyl acetoacetate), titanium mono-tert-butoxy-tris(ethyl acetoacetate), titanium tetrakis(ethyl acetoacetate), titanium mono(acetyl acetonate)-tris(ethyl acetoacetate), titanium bis(acetyl acetonate)-bis(ethyl acetoacetate) and titanium tris-(acetyl acetonate)-mono(ethyl acetoacetate);

Chelate compounds of zirconium such as zirconium tri-ethoxy-mono(acetyl acetonate), zirconium tri-n-propoxy-mono(acetyl acetonate), zirconium tri-iso-propoxy-mono(acetyl acetonate), zirconium tri-n-butoxy-mono(acetyl acetonate), zirconium tri-sec-butoxy-mono(acetyl acetonate), zirconium tri-tert-butoxy-mono(acetyl acetonate), zirconium di-ethoxy-bis(acetyl acetonate), zirconium di-n-propoxy-bis(acetyl acetonate), zirconium di-iso-propoxy-bis(acetyl acetonate), zirconium di-n-butoxy-bis(acetyl acetonate), zirconium di-sec-butoxy-bis(acetyl acetonate), zirconium di-tert-butoxy-bis-(acetyl acetonate), zirconium mono-ethoxy-tris-(acetyl acetonate), zirconium mono-n-propoxy-tris(acetyl acetonate), zirconium mono-iso-propoxy-tris(acetyl acetonate), zirconium mono-n-butoxy-tris(acetyl acetonate), zirconium mono-sec-butoxy-tris(acetyl acetonate), zirconium mono-tert-butoxy-tris(acetyl acetonate), zirconium tetrakis(acetyl acetonate), zirconium tri-ethoxy-mono(ethyl acetoacetate), zirconium tri-n-propoxy-mono(ethyl acetoacetate), zirconium tri-iso-propoxy-mono(ethyl acetoacetate), zirconium tri-n-butoxy-mono(ethyl acetoacetate), zirconium tri-sec-butoxy-mono(ethyl acetoacetate), zirconium tri-tert-butoxy-mono(ethyl acetoacetate), zirconium di-ethoxy-bis(ethyl acetoacetate), zirconium di-n-propoxy-bis-(ethyl acetoacetate), zirconium di-iso-propoxy-bis(ethyl acetoacetate), zirconium di-n-butoxy-bis(ethyl acetoacetate), zirconium di-sec-butoxy-bis(ethyl acetoacetate), zirconium di-tert-butoxy-bis(ethyl acetoacetate), zirconium mono-ethoxy-tris(ethyl acetoacetate), zirconium mono-n-propoxy-tris(ethyl acetoacetate), zirconium mono-iso-propoxy-tris-(ethyl acetoacetate), zirconium mono-n-butoxy-tris(ethyl acetoacetate), zirconium mono-sec-butoxy-tris(ethyl acetoacetate), zirconium mono-tert-butoxy-tris(ethyl acetoacetate), zirconium tetrakis-(ethyl acetoacetate), zirconium mono(acetyl acetonate)-tris(ethyl acetoacetate), zirconium bis(acetyl acetonate)-bis(ethyl acetoacetate) and zirconium tris(acetyl acetonate)-mono(ethyl acetoacetate);

Chelate compounds of aluminum such as aluminum tris(acetyl acetonate) and aluminum tris(ethyl acetoacetate); and other chelate compounds.

Examples of organic acids are acetic acid, propionic acid, butanoic acid, pentanoic acid, hexanoic acid, heptanoic acid, octanoic acid, nonanoic acid, decanoic acid, oxalic acid, maleic acid, methyl malonic acid, adipic acid, sebacic acid, gallic acid, butyric acid, mellitic acid, arachidonic acid, michimic acid, 2-ethylhexanoic acid, oleic acid, stearic acid, linoleic acid, linolenic acid, salicylic acid, benzoic acid, p-amino-benzoic acid, p-toluene-sulfonic acid, benzene-sulfonic acid, monochloro-acetic acid, dichloro-acetic acid, trichloro-acetic acid, trifluoro-acetic acid, formic acid malonic acid, sulfonic acid, phthalic acid, fumaric acid, citric acid and tartaric acid. Examples of inorganic acids are hydrochloric acid, nitric acid, sulfuric acid and phosphoric acid.

Specific examples of organic bases are pyridine, pyrrole, piperazine, pyrrolidine, piperidine, pyridine, picoline, trimethylamine, triethylamine, mono-ethanolamine, di-ethanolamine, dimethyl monoethanolamine, monomethyl diethanolamine, tri-ethanolamine, diaza-bicyclo-octane, diaza-bicyclo-nonane, diaza-bicyclo-undecene and tetramethyl-ammonium hydroxide. Specific examples of inorganic bases are ammonia, sodium hydroxide, potassium hydroxide, barium hydroxide and calcium hydroxide.

Among these catalysts, preferably used herein are metal chelate compounds, organic acids and inorganic acids and catalysts more preferably used herein include chelate compounds of titanium and organic acids. These catalysts may be used alone or in any combination of at least two of them.

To subject the silane compounds of Formulas (I) and (II) according to the present invention to hydrolyzation and partial condensation, it is preferred to add water in an amount ranging from 0.25 to 3 moles and, in particular, 0.3 to 2.5 moles per mole of the alkoxy groups present on the whole silane compound. More specifically, it is sufficient that water is continuously or intermittently added to an organic solvent in which the silane compound is dissolved. The catalyst may be added to the organic solvent in advance or may be dissolved or dispersed in water to be added to the solvent. The reaction temperature of the hydrolyzation and partial condensation usually ranges from 0 to 100° C. and preferably 15 to 80° C.

The reaction time may vary depending on the reaction temperature selected. In general, however, the reaction time preferably ranges from 0.5 to 100 hours and more preferably 1 to 24 hours, while taking into consideration the reliability of the reaction and the productivity.

Furthermore, the pH value of the film-forming composition is preferably controlled to a level of not higher than 7 after the hydrolyzation and partial condensation of the silane compound. Examples of methods for adjusting the pH value of the composition include a method in which a pH adjuster is added to the composition and a method in which the component (B) is distilled off from the composition. These methods may be used alone or in combination.

In this connection, the foregoing pH adjuster may be, for instance, an inorganic acid and an organic acid. Specific examples of such inorganic acids are hydrochloric acid, nitric acid, sulfuric acid and phosphoric acid. In addition, specific examples of such organic acids are acetic acid, propionic acid, oxalic acid, maleic acid, citric acid, tartaric acid, succinic acid, fumaric acid, itaconic acid, mesaconic acid, citraconic acid, malic acid, hydrolyzate of glutaric anhydride, hydrolyzate of maleic anhydride and hydrolyzate of phthalic anhydride.

These compounds may be used alone or in any combination of at least two of them.

The pH value of the composition is adjusted to a level of not higher than 7 and preferably 1 to 6 with the foregoing pH adjuster. The control of the pH value of the composition to the level specified above would permit the improvement of the storage stability of the resulting composition. The amount of the pH adjuster may appropriately be selected.

The total solid content of the composition of the present invention thus obtained may appropriately be adjusted depending on the purposes and preferably ranges from 2 to 30% by mass. The use of the composition whose total solid content falls within the range of from 2 to 30% by mass would permit the formation of a coated layer having a thickness falling within a reasonable range and such a solid content would likewise permit the improvement of the storage stability of the composition.

The coating composition for forming an insulating film according to the present invention thus prepared may be applied onto the surface of a base material such as a silicon wafer, an SiO₂ wafer or an SiN wafer by any coating means such as spin coating, dip coating, roll coating and/or spray coating techniques.

At this stage, the thickness of the coated layer is on the order of about 0.05 to 1.5 μm in case of the one-stage coating and about 0.1 to 3 μm in case of the two-stage coating, as expressed in terms of the thickness determined after drying. Thereafter, the coated layer is dried at ordinary temperature or by heating at a temperature ranging from about 80 to 600° C. for a time usually ranging from about 5 to 240 minutes to thus form an insulating film of a vitreous substance, a macromolecular material or a mixture thereof. In this respect, the heating operation can be carried out using a heating means such as a hot plate, an oven or a furnace, in a heating atmosphere or environment, for instance, in the air, in a nitrogen gas atmosphere, in an argon gas atmosphere, in a vacuum or in an atmosphere of reduced pressure, whose oxygen content is controlled.

More specifically, the insulating film-forming coating composition of the present invention can be applied onto a substrate (usually a substrate provided thereon with metal distributing wires) according to, for instance, the spin coating technique, then subjected to a first heat treatment carried out at a temperature of not higher than 300° C. over one minute to one hour to thus eliminate the solvent, to dry the coated layer of the composition and to make the siloxane included in the film-forming composition crosslink and then subjected to a second heat treatment (anneal treatment) carried out at a temperature of higher than 300° C. and not higher than 450° C. over 30 minutes to 10 hours to thus form an insulating film having a low dielectric constant. In this connection, the temperature of not higher than 300° C. is used in the first heat treatment in order to make the control of the degree of crosslinking easy, while preventing any progress of the crosslinking to an undue extent, while the temperature of higher than 300° C. and not higher than 450° C. is used in the second heat treatment for the reason that the temperature falling within the range is usually quite suitable for the annealing.

The crosslinking of the siloxane by the first heat treatment proceeds while forming Si—O—Si bonds through the oxidation thereof and therefore, this first heat treatment can advantageously be conducted in the atmosphere. Moreover, the degree of crosslinking may be adjusted to control the dielectric constant of the resulting insulating film and, in this respect, the degree of crosslinking can be controlled by appropriately adjusting the temperature and time of this heat treatment.

Further, in the present invention, the resulting insulating film may be made porous if the void content is controlled upon the formation of the film to thus give an insulating film having a lower dielectric constant or a porous film having a dielectric constant of not higher than 2.5 and preferably not higher than 2.1.

The interlayer insulating film thus prepare is quite excellent in the insulating characteristics as well as excellent in uniformity of the film, the dielectric characteristics, the resistance of the film to cracking and the surface hardness of the film and accordingly, the film may effectively be used as an interlayer insulating film for various semiconductor elements such as LSI, system LSI, DRAM, SDRAM, RDRAM and D-RDRAM, a protective film such as a surface coating film for semiconductor elements, an interlayer insulating film for substrates provided thereon with multi-layer distributing wires, and a protective film or an insulating film for liquid crystal display elements.

### EXAMPLES

The present invention will hereunder be described in more specifically with reference to the following non-limitative working Examples. In the following Examples, the terms “part” and “%” are “part by mass” and “% by mass” respectively, unless otherwise specified. Moreover, the film-forming composition in the following Examples were evaluated as follows:

[Dielectric Constant]

A sample of each composition was coated on a 6-inch-thickness silicon wafer using the spin coating technique, the substrate was dried at 80° C. for 5 minutes and then at 200° C. for 5 minutes on a hot plate and the substrate was further calcined in a nitrogen gas atmosphere for 60 minutes in an oven maintained at 450° C. Then aluminum was vapor-deposited on the resulting substrate to thus give a substrate for use in the evaluation of the dielectric constant thereof. The dielectric constant of each sample was calculated from the capacity value observed at 10 kHz as determined using HP16451B electrodes and HP4284A Precision LCR Meter available from YOKOKAWA-Hewlett-Packard K.K.

[Adhesive Properties]

The film obtained by depositing SiO₂ film having a thickness of 0.1 μm (CVD technique) on the foregoing film was subjected to a lattice pattern cutting test (tape-peeling test) according to the method specified in JIS K5400.

(Evaluation Criteria)

There is not observed any peeling of the film: ∘

There is observed peeling of the film: x

[Resistance to Cracking]

A sample of each composition was coated on a 6-inch-thickness silicon wafer using the spin coating technique, the substrate was dried at 80° C. for 5 minutes and then at 200° C. for 5 minutes on a hot plate and the substrate was further calcined in a nitrogen gas atmosphere for 60 minutes in an oven maintained at 450° C. At this stage, the thickness of the coated film was set at 1 μm. The resulting film was immersed in pure water for one hour and then the film was inspected for the appearance using a lamp of 350,000 1× for the surface-observation to thus evaluate each sample film on the basis of the following criteria:

There is not observed any crack on the film surface: ∘

There are observed cracks on the film surface: x

### Preparation Example 1

Preparation of Reaction Solution I

To a quartz separable flask, there were added 471 g of ethanol, 237 g of ion-exchanged water and 17.2 g of a 25% aqueous tetramethyl ammonium hydroxide solution and the resulting mixture was uniformly stirred. To this solution, there was added a mixture containing 20 g of vinyl tri-ethoxy silane, 30 g of methyl tri-methoxy silane and 50 g of tetra-ethoxy silane. The reaction was continued over 2 hours while maintaining the temperature of the resulting solution at 55° C. To this solution, there were added 28 g of a 20% aqueous solution of maleic acid and 440 g of propylene glycol mono-methyl ether (boiling point: 118° C.) and then the resulting solution was concentrated at 50° C. using an evaporator to a concentration of 10% (as expressed in terms of the concentration of the completely hydrolyzed and condensed product). To the resulting solution, there were added 300 g of ethyl acetate and 300 g of ion-exchanged water to thus carry out liquid-liquid extraction. The solution as the upper phase was removed and then concentrated to a concentration of 10% (as expressed in terms of the concentration of the completely hydrolyzed and condensed product) using an evaporator to thus obtain a reaction solution 1.

### Preparation Example 2

Synthesis of Hollow Polymer Fine Particles 1

An aqueous solution obtained by dissolving 0.5 part of sodium lauryl sulfate and 1.0 part of potassium persulfate in 200 parts of water was added to a mixture comprising 80 parts of styrene, 18 parts of butadiene, 2 parts of itaconic acid and 10 parts of t-dodecyl mercaptan with stirring, followed by the polymerization of these monomers at 65° C. for 6 hours to thus give polymer particles. In this respect, it was found that the polymer particles had an average particle size of 0.25 μm, a toluene-insoluble content of 4%, a number average molecular weight as determined by GPC technique of 5,000 and the ratio of the weight average molecular weight to the number average molecular weight (Mw/Mn) of 2.6.

Then the following polymerization was conducted using the polymer particles as a seed polymer. More specifically, there were dispersed, in 900 parts of water, 10 parts of the polymer particles, 0.1 part of polyoxyethylene nonyl phenyl ether, 0.4 part of sodium lauryl sulfate 0.5 part of potassium persulfate. To the resulting dispersion, there were added 30 parts of methyl methacrylate, 50 parts of divinyl-benzene, 20 parts of α-methyl-styrene and 20 parts of toluene, followed by the polymerization of the foregoing monomers at 65° C. for 5 hours to thus obtain a dispersion of capsule particles containing toluene within the particles in a polymerization yield of 98%. After the dispersion was subjected to a steam-stripping treatment, the polymer particles were observed by a transmission electron microscope and as a result, the polymer particles were found to be transparent at the central portions thereof and completely spherical hollow polymer fine particles. Further, it was also found that the particles had an outer diameter of 0.44 μm, an inner diameter of 0.3 μm and a specific gravity of 0.72. The resulting hollow polymer particles were subjected to spray-drying treatment to thus obtain hollow polymer fine particles 1. The resulting hollow polymer fine particles had an average particle size of 0.45 μm and the rate of the particles occupied by those having a particle size of the average particle size ±20% was found to be not less than 80% by mass.

### Example 1

To the reaction solution 1 prepared in Preparation Example 1, there was added 120 parts by mass of 1,2-tetadecane-diol (boiling point 172° C./20 mmHg) relative to 100 parts by mass of the component (A) of the reaction solution. The resulting solution was filtered through a Teflon (registered trade mark) having a pore size of 0.2 μm to thus give a coating composition for forming a film according to the present invention. The resulting composition was applied onto the surface of a silicon wafer according to the spin coating technique and then the coated layer was calcined to give a film. The film was inspected for a variety of characteristic properties. The results thus obtained are summarized in the following Table 1.

### Example 2

The same procedures used in Preparation Example 1 and Example 1 were repeated except that a 25% aqueous solution of tetramethyl ammonium maleate was substituted for the 25% aqueous solution of tetramethyl ammonium hydroxide used in Preparation Example 1 and that 1,8-octane-diol was substituted for the 1,2-tetra-decane-diol used in Example 1 to evaluate various characteristic properties of the coated film prepared in this Example. The evaluated results of this coated film are listed in Table 1.

### Example 3

The same procedures used in Preparation Example 1 and Example 1 were repeated except that a 25% aqueous solution of diaza-bicyclo-undecene acetate was substituted for the 25% aqueous solution of tetramethyl ammonium hydroxide used in Preparation Example 1 and that the added amount of the 1,2-tetradecane-diol used in Example 1 was changed to 55 parts by mass to evaluate various characteristic properties of the coated film prepared in this Example. The evaluated results of this coated film are listed in Table 1.

### Example 4

The same procedures used in Preparation Example 1 and Example 1 were repeated except that a 25% aqueous solution of tetramethyl ammonium chloride was substituted for the 25% aqueous solution of tetramethyl ammonium hydroxide used in Preparation Example 1 and that the added amount of the 1,2-tetradecane-diol used in Example 1 was changed to 150 parts by mass to evaluate various characteristic properties of the coated film prepared in this Example. The evaluated results of this coated film are listed in Table 1.

### Comparative Example 1

The same procedures used in Preparation Example 1 were repeated except that 20 g of vinyl tri-ethoxy silane was not used in Preparation Example 1 to thus form a reaction solution. Then the same procedures used in Example 1 were repeated using the reaction solution thus prepared to evaluate various characteristic properties of the coated film prepared in this Comparative Example. The evaluated results of this coated film are listed in Table 1.

### Comparative Example 2

The same procedures used in Example 1 were repeated except that poly(methyl methacrylate) was used in place of the 1,2-tetradecane-diol used in Example 1 to conduct the evaluation of the coated film prepared in this Comparative Example. The evaluated results of this coated film are listed in Table 1.

### Comparative Example 3

The same procedures used in Example 1 were repeated except that the 1,2-tetradecane-diol used in Example 1 was not used at all to evaluate various characteristic properties of the coated film prepared in this Comparative Example. The evaluated results of this coated film are listed in Table 1.

TABLE 1

| | Relative Dielectric | Adhesive | Resistance |
|---|---|---|---|
| | Constant | Properties | to Cracking |
| Example 1 | 1.92 | ◯ | ◯ |
| Example 2 | 1.98 | ◯ | ◯ |
| Example 3 | 2.01 | ◯ | ◯ |
| Example 4 | 1.80 | ◯ | ◯ |
| Comparative Ex. 1 | 2.04 | X | ◯ |
| Comparative Ex. 2 | 2.25 | ◯ | X |
| Comparative Ex. 3 | 2.53 | ◯ | X |

The data listed in Table 1 clearly indicate that the films prepared in Examples 1 to 4 from the compositions of the present invention have low dielectric constants, and they are excellent in the adhesive properties and the resistance to cracking, while the film prepared in Comparative Example 1 and free of any compound of Formula (I) has low adhesive properties and the films prepared in Comparative Examples 2 and 3 in which any void-forming solvent is not used have high adhesive properties, but they have high dielectric constants and insufficient resistance to cracking.

### Example 5

To the reaction solution 1 prepared in Preparation Example 1, there was added 20 parts by mass of polyethylene oxide block-polypropylene oxide block-polyethylene oxide block copolymer (NEWPOLE PE61 available from SANYO Chemical Industries, Ltd.) relative to 100 parts by mass of the component (A) of the reaction solution. The resulting solution was filtered through a Teflon (registered trade mark) having a pore size of 0.2 μm to thus give a coating composition for forming a film according to the present invention. The resulting composition was applied onto the surface of a silicon wafer according to the spin coating technique and then the coated layer was calcined to give a film. The film was inspected for a variety of characteristic properties. The results thus obtained are summarized in the following Table 2.

### Example 6

The same procedures used in Preparation Example 1 and Example 5 were repeated except that a 25% aqueous solution of tetramethyl ammonium maleate was substituted for the 25% aqueous solution of tetramethyl ammonium hydroxide used in Preparation Example 1 and that Polyethylene Glycol #600 was substituted for the polyethylene oxide block-polypropylene oxide block-polyethylene oxide block copolymer used in Example 5 to conduct the evaluation of the film obtained from the composition prepared in this Example. The evaluated results of this coated film are listed in Table 2.

### Example 7

The same procedures used in Preparation Example 1 and Example 5 were repeated except that a 25% aqueous solution of diaza-bicyclo-undecene acetate was substituted for the 25% aqueous solution of tetramethyl ammonium hydroxide used in Preparation Example 1 and that the added amount of the polyethylene oxide block-polypropylene oxide block-polyethylene oxide block copolymer used in Example 5 was changed to 55 parts by mass to evaluate various characteristic properties of the film obtained from the composition prepared in this Example. The evaluated results of this coated film are listed in Table 2.

### Example 8

The same procedures used in Preparation Example 1 and Example 5 were repeated except that a 25% aqueous solution of tetramethyl ammonium chloride was substituted for the 25% aqueous solution of tetramethyl ammonium hydroxide used in Preparation Example 1 and that the added amount of the polyethylene oxide block-polypropylene oxide block-polyethylene oxide block copolymer used in Example 5 was changed to 80 parts by mass to evaluate various characteristic properties of the film obtained from the composition prepared in this Example. The evaluated results of this coated film are listed in Table 2.

### Comparative Example 4

The same procedures used in Preparation Example 1 were repeated except that 20 g of vinyl tri-ethoxy silane was not used in Preparation Example 1 to thus form a reaction solution. Then the same procedures used in Example 5 were repeated using the resulting reaction solution to evaluate various characteristic properties of the coated film prepared in this Comparative Example. The evaluated results of this coated film are listed in Table 2.

### Comparative Example 5

The same procedures used in Example 5 were repeated except that poly(methyl methacrylate) was used in place of the polyethylene oxide block-polypropylene oxide block-polyethylene oxide block copolymer used in Example 5 to evaluate various characteristic properties of the coated film prepared in this Comparative Example. The evaluated results of this coated film are listed in Table 2.

### Comparative Example 6

The same procedures used in Example 5 were repeated except that the polyethylene oxide block-polypropylene oxide block-polyethylene oxide block copolymer used in Example 5 was not used at all to evaluate various characteristic properties of the coated film prepared in this Comparative Example. The evaluated results of this coated film are listed in Table 2.

TABLE 2

| | Relative Dielectric | Adhesive | Resistance |
|---|---|---|---|
| | Constant | Properties | to Cracking |
| Example 5 | 2.02 | ◯ | ◯ |
| Example 6 | 1.98 | ◯ | ◯ |
| Example 7 | 1.90 | ◯ | ◯ |
| Example 8 | 1.80 | ◯ | ◯ |
| Comparative Ex. 4 | 2.02 | X | ◯ |
| Comparative Ex. 5 | 2.25 | ◯ | X |
| Comparative Ex. 6 | 2.53 | ◯ | X |

The data listed in Table 2 clearly indicate that the films prepared in Examples 5 to 8 from the compositions of the present invention have low dielectric constants, and they are excellent in the adhesive properties and the resistance to cracking, while the film prepared in Comparative Example 4 and free of any compound of Formula (I) has low adhesive properties and the films prepared in Comparative Examples 5 and 6 in which any compound having a polyalkylene oxide structure is not used have high adhesive properties, but they have high dielectric constants and insufficient resistance to cracking.

### Example 9

To the reaction solution 1 prepared in Preparation Example 1, there was added 30 parts by mass of the hollow polymer fine particles 1 with respect to 100 parts by mass of the component (A) of the reaction solution. The resulting solution was filtered through a Teflon (registered trade mark) having a pore size of 0.2 μm to thus give a coating composition for forming a film according to the present invention. The resulting composition was applied onto the surface of a silicon wafer according to the spin coating technique and then the coated layer was calcined to give a film. The film was inspected for a variety of characteristic properties. The results thus obtained are summarized in the following Table 3.

### Example 10

The same procedures used in Preparation Example 1 were repeated except that a 25% aqueous solution of tetramethyl ammonium maleate was substituted for the 25% aqueous solution of tetramethyl ammonium hydroxide used in Preparation Example 1 to prepare a reaction solution. The same procedures used in Example 9 were repeated using the resulting reaction solution to conduct the evaluation of the film obtained from the composition prepared in this Example. The evaluated results of this coated film are listed in Table 3.

### Example 11

The same procedures used in Preparation Example 1 and Example 9 were repeated except that a 25% aqueous solution of diaza-bicyclo-undecene acetate was substituted for the 25% aqueous solution of tetramethyl ammonium hydroxide used in Preparation Example 1 and that the added amount of the hollow polymer fine particles 1 used in Example 9 was changed to 55 parts by mass to conduct the evaluation of the film obtained from the composition prepared in this Example. The evaluated results of this coated film are listed in Table 3.

### Example 12

The same procedures used in Preparation Example 1 and Example 5 were repeated except that a 25% aqueous solution of tetramethyl ammonium chloride was substituted for the 25% aqueous solution of tetramethyl ammonium hydroxide used in Preparation Example 1 and that the added amount of the hollow polymer fine particles 1 used in Example 9 was changed to 80 parts by mass to evaluate various characteristic properties of the film obtained from the composition prepared in this Example. The evaluated results of this coated film are listed in Table 3.

### Comparative Example 7

The same procedures used in Preparation Example 1 were repeated except that 20 g of vinyl tri-ethoxy silane was not used in Preparation Example 1 to thus form a reaction solution. Then the same procedures used in Example 9 were repeated using the resulting reaction solution to evaluate various characteristic properties of the coated film prepared in this Comparative Example. The evaluated results of this coated film are listed in Table 3.

### Comparative Example 8

The same procedures used in Example 9 were repeated except that poly(methyl methacrylate) was used in place of the hollow polymer fine particles 1 used in Example 9 to evaluate various characteristic properties of the coated film prepared in this Comparative Example. The evaluated results of this coated film are listed in Table 3.

### Comparative Example 9

The same procedures used in Example 9 were repeated except that the hollow polymer fine particles 1 used in Example 9 was not used at all to evaluate various characteristic properties of the coated film prepared in this Comparative Example. The evaluated results of this coated film are listed in Table 3.

TABLE 3

| | Relative Dielectric | Adhesive | Resistance to |
|---|---|---|---|
| | Constant | Properties | Cracking |
| Example 9 | 2.04 | ◯ | ◯ |
| Example 10 | 1.98 | ◯ | ◯ |
| Example 11 | 1.92 | ◯ | ◯ |
| Example 12 | 1.83 | ◯ | ◯ |
| Comparative Ex. 7 | 2.22 | X | ◯ |
| Comparative Ex. 8 | 2.25 | ◯ | X |
| Comparative Ex. 9 | 2.53 | ◯ | X |

The data listed in Table 3 clearly indicate that the films prepared in Examples 9 to 12 from the compositions of the present invention have low dielectric constants, and they are excellent in the adhesive properties and the resistance to cracking, while the film prepared in Comparative Example 7 and free of any compound of Formula (I) has low adhesive properties and the films prepared in Comparative Examples 8 and 9 in which hollow polymer fine particles are not used have high adhesive properties, but they have high dielectric constants and insufficient resistance to cracking.

As has been described above in detail, when the composition of the present invention comprising polyorgano-siloxane as a base polymer is applied onto, for instance, a silicon wafer, the composition can certainly fill up, for instance, the gaps present between fine patterns. As a result, if the organic solvent used for the coating is removed and the layer is crosslinked, through heating, a vitreous or macromolecular film can be formed. The resulting film is excellent in the heat resistance and adhesion to other materials, has a low dielectric constant and never undergoes the formation of any crack. The composition of the invention thus permits the formation of a thick insulating film.

What is claimed is:

1. A coating composition for forming a silica-containing film comprising (A) a hydrolyzate and/or partially condensed product of a compound represented by the following general formula (I) and a compound represented by the following general formula (II): 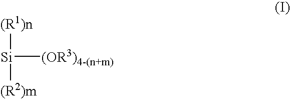
wherein R¹ represents a hydrogen atom, an alkyl group having 1 to 18 carbon atoms or an aryl group having 6 to 14 carbon atoms; R² represents an organic group having an unsaturated bond and 2 to 12 carbon atoms; R³ represents an alkyl group having 1 to 6 carbon atoms; n is an integer ranging from 0 to 2; m is an integer ranging from 1 to 3, provided that n and m are selected such that they satisfy the following relation: 0≦n+m≦3; and 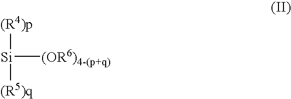
wherein R⁴ represents an alkyl group having 1 to 18 carbon atoms or an aryl group having 6 to 14 carbon atoms; R⁵ represents a hydrogen atom; R⁶ represents an alkyl group having 1 to 6 carbon atoms; and p and q are integers selected in such a manner that they satisfy the following relation: 0≦p+q≦3;
(B) a solvent for coating; and
(C) at least one member selected from the group consisting of a void-forming solvent, a compound having a polyalkylene oxide structure and hollow polymer fine particles.

2. The coating composition for forming a silica-containing film as set forth in claim 1, wherein the component (C) is a void-forming solvent.

3. The coating composition for forming a silica-containing film as set forth in claim 1, wherein the component (C) is a compound having a polyalkylene oxide structure.

4. The coating composition for forming a silica-containing film as set forth in claim 1, wherein the component (C) is hollow polymer fine particles.

5. A method for forming a silica-containing film comprising the steps of applying a coating composition for forming a silica-containing film as set forth in any one of the foregoing claims 1 to 4 onto a base material and then drying the coated layer.

6. A silica-containing film obtained from a coating composition for forming a silica-containing film as set forth in any one of the foregoing claims 1 to 4.
